(19) United States
(12) Patent Application Publication
(10) Pub. No.: US 2013/0172081 A1
(43) Pub. Date: Jul. 4, 2013

(54) GAME DEVICE, GAME CONTROL METHOD, AND GAME CONTROL PROGRAM, FOR CONTROLLING PICTURE DRAWING GAME

(71) Applicant: SONY COMPUTER ENTERTAINMENT INC., Tokyo (JP)

(72) Inventors: Hiroshi Shiina, Tokyo (JP); Yasuhiro Kawagoe, Tokyo (JP); Masamitsu Okuda, Saitama (JP); Ichiro Ebisu, Tokyo (JP)

(73) Assignee: SONY COMPUTER ENTERTAINMENT INC., Tokyo (JP)

(21) Appl. No.: 13/717,903

(22) Filed: Dec. 18, 2012

Related U.S. Application Data
(63) Continuation of application No. PCT/JP2010/005613, filed on Sep. 14, 2010.

(30) Foreign Application Priority Data
Jun. 28, 2010 (JP) 2010-146754
Jun. 28, 2010 (JP) 2010-146755

(51) Int. Cl. A63F 13/06; A63F 13/02

(52) U.S. Cl. CPC A63F 13/06; A63F 13/02
USPC 463/31; 463/36; 463/35

(57) ABSTRACT

A game device comprises: a drawing control unit configured to move a pointer that indicates a drawing position based on a control command of a player, and to draw a picture at a position of the pointer based on a control command of the player; and an sound output unit configured to output sound as determined by the position of the pointer when the picture is drawn.

### BACKGROUND OF THE INVENTION

1. Field of the Invention

The present invention relates to a game control technology and, more particularly, to a game device, game control method, and game control program configured to control a game configured to draw a picture based on a control command of the player.

2. Description of the Related Art

There are software programs which allow the user to draw a desired picture. By selecting a pen and a color for drawing a picture, and by operating a pointing device such as a mouse, pen tablet, or the like, such an arrangement allows the user to draw a picture at a desired position.

### RELATED ART DOCUMENTS

Patent Documents

Patent Document 1
U.S. Pat. No. 6,741,742 (which corresponds to Japanese Patent Application Laid Open No. 2001-195593)

The present inventors have arrived at an idea for a technique for providing novel entertainment to a player who plays a game configured to draw a picture based on a control command from the player.

### SUMMARY OF THE INVENTION

In this background, a general purpose of the present invention is to provide a game control technology providing higher entertainment value.

An embodiment of the present invention relates to a game control program. The game control program is configured to instruct a computer to provide: a function of moving a pointer that indicates a drawing position based on a control command of a player; a function of drawing a picture at a position of the pointer based on a control command of the player; and a function of outputting sound as determined by the position of the pointer when the picture is drawn.

Another embodiment of the present invention also relates to a game control program. The game control program is configured to instruct a computer to provide: a function of outputting background sound; a function of displaying a process for drawing a first picture that a player is to draw, concurrently with the background sound; a function of drawing a second picture based on an operating input of the player; a function of evaluating the accuracy of a timing at which the player has drawn the second picture by making a comparison between a process in which the second picture was drawn and a process in which the first picture was drawn; and a function of outputting a sound based on the accuracy of the timing at which the player has drawn the second picture when the second picture is drawn.

It should be noted that any combination of the aforementioned components or any manifestation thereof may be mutually substituted between a method, apparatus, system, and so forth, which are effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows an environment in which a game system according to an embodiment of the present invention is used;

FIGS. 2A and 2B are diagrams each showing the appearance of the input device;

FIG. 3 is a diagram which shows the internal configuration of the input device;

FIG. 4 is a diagram which shows the configuration of the game device;

FIG. 5 is a diagram which shows the configuration of the application processing unit;

FIG. 6 is a diagram which shows the player drawing a picture using the game device according to the embodiment;

FIG. 7 is a diagram which shows the player drawing a picture using the game device according to the embodiment;

FIG. 8 is a diagram which shows the properties of the sound output from an audio output unit based on the position of the input device;

FIG. 9 shows an example of the sound output from the audio output unit;

FIGS. 10A and 10B are diagrams for describing the operation of a mirror mode control unit;

FIGS. 11A and 11B are diagrams for describing the operation of the mirror mode control unit;

FIG. 12 is a diagram which shows the configuration of an application processing unit according to a second embodiment;

FIG. 13 is a diagram which shows a model picture which the player is to draw;

FIG. 14 is a diagram which shows a screen on which is displayed a model line which the player is to draw in the next stage;

FIG. 15 is a diagram which shows an example of a screen for presenting a timing at which the player is to draw a line in the next stage;

FIG. 16 is a diagram which shows an example of a screen for presenting a timing at which the player is to draw a line in the next stage;

FIG. 17 is a diagram which shows the player drawing a line imitating a model picture;

FIG. 18 is a diagram which shows the player drawing a line imitating a model picture;

FIG. 19 is a diagram which shows the player drawing a line imitating a model picture;

FIG. 20 is a diagram for describing a method used by an evaluation unit for evaluating how accurately the player has drawn a picture; and

FIG. 21 is a diagram which shows an example of the evaluation result obtained by the evaluation unit.

### DETAILED DESCRIPTION OF THE INVENTION

The invention will now be described by reference to the preferred embodiments. This does not intend to limit the scope of the present invention, but to exemplify the invention.

### First Embodiment

A game device according to an embodiment provides a function of instructing an imaging device to capture an image of a player holding an input device which allows the player to perform an input operation for drawing a picture, and a function of drawing a picture by following the track of movement of the input device which is moved by the player within an imaging region of the imaging device. A game device instructs a display device to display an image obtained by superimposing a picture drawn via the input device on the image captured by the imaging device. Thus, such an arrangement allows the player to draw a picture while viewing an image of the player himself/herself operating the input device, as if the player were drawing a picture on a transparent plane virtually prepared in front of the player himself/herself. Furthermore, the game device according to the present embodiment provides a function of outputting sound according to the position of the input device at the time when a picture is being drawn. Thus, such an arrangement allows the player to draw a picture while playing rhythmical music, which provides novel entertainment.

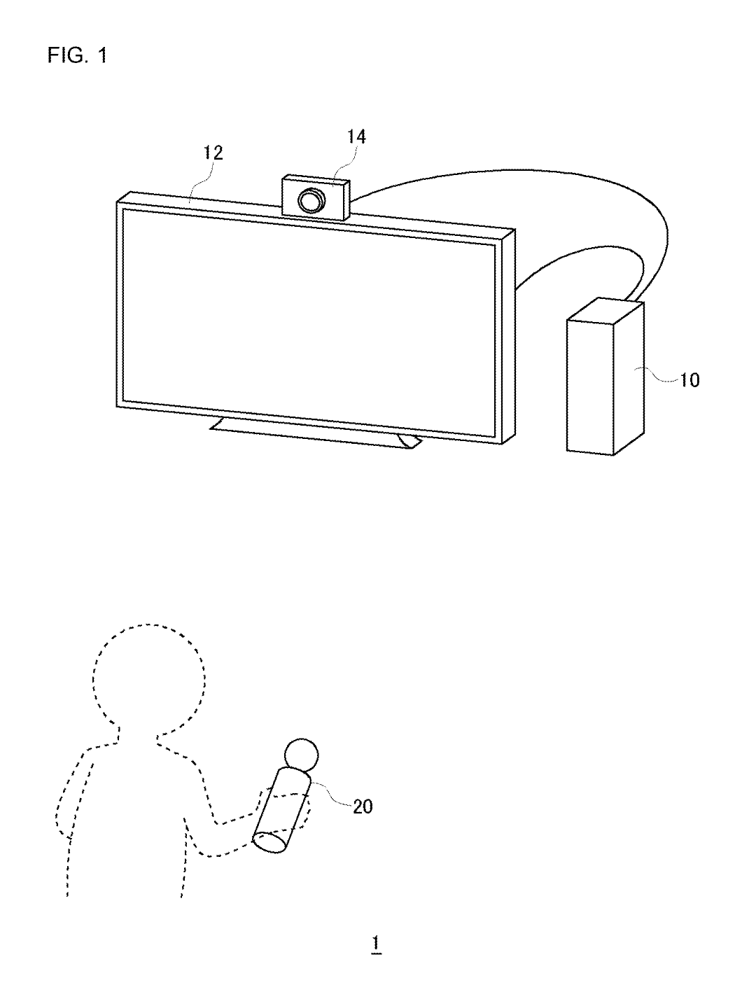

FIG. 1 shows an environment in which a game system 1 according to an embodiment of the present invention is used. The game system 1 comprises a game device 10 adapted to run game software, a display device 12 adapted to output the result of processing by the game device 10, an input device 20, and an imaging device 14 adapted to image the input device 20.

The input device 20 is a user input device that allows a user to provide a command. The game device 10 is a processing device adapted to run a game application in accordance with a user command provided via the input device 20 and generate an image signal indicating the result of processing the game application.

The input device 20 has the function of transferring a control command of a user to the game device 10 and is configured, according to the embodiment, as a wireless controller capable communicating with the game device 10 wirelessly. The input device 20 and the game device 10 may establish wireless connection using the Bluetooth (registered trademark) protocol. The input device 20 may not be a wireless controller but may be a wired controller connected to the game device 10 using a cable.

The input device 20 is driven by a battery and is provided with multiple buttons used to provide a user command to advance a game. As the user operates the button of the input device 20, the control command is transmitted to the game device 10 wirelessly. The game device 10 receives the user command from the input device 20, controls the progress of the game in accordance with the user command, and generates a game image signal. The generated game image signal is output from the display device 12.

The imaging device 14 is a video camera comprising a CCD imaging device, a CMOS imaging device, etc. The device 14 captures an image of a real space at predetermined intervals so as to generate periodical frame images. For example, the imaging device 14 may capture 30 images per second to match the frame rate of the display device 12. The imaging device 14 is connected to the game device 10 via a universal serial bus (USB) or another interface.

The display device 12 is a display that outputs an image and displays a game screen by receiving an image signal generated by the game device 10. The display device 12 may be a television set provided with a display and a speaker. Alternatively, the display device 12 may be a computer display. The display device 12 may be connected to the game device 10 using a cable. Alternatively, the device 12 may be wirelessly connected using a wireless local area network (LAN).

The input device 20 in the game system 1 according to the embodiment is provided with a light-emitting body. During the game, the light-emitting body emits light of a predetermined color, which is imaged by the imaging device 14. The imaging device 14 captures an image of the input device 20, generates a frame image accordingly, and supplies the image to the game device 10. The game device 10 acquires the frame image and derives information on the position of the light-emitting body in the real space by referring to the position and size of the image of the light-emitting body in the frame image. The game device 10 deals with the positional information as a command to control the game and reflects the information in game processing by, for example, controlling the action of a player's character. The game device 10 according to the embodiment is provided with the function of running a game program not only using a control input provided via the button of the input device 20 but also using the positional information of the acquired image of the light-emitting body.

The light-emitting body of the input device 20 is configured to emit light of multiple colors. The color emitted by the light-emitting body can be configured according to a command for light emission from the game device 10.

The input device 20 is provided with an acceleration sensor and a gyro sensor. The value detected by the sensor is transmitted to the game device 10 at predetermined intervals. The game device 10 acquires the value detected by the sensor so as to acquire information on the orientation of the input device 20 in the real space. The game device 10 deals with the orientation information as a user command in the game and reflects the information in game processing. Thus, the game device 10 according to the embodiment has the function of running a game application using the acquired orientation information of the input device 20.

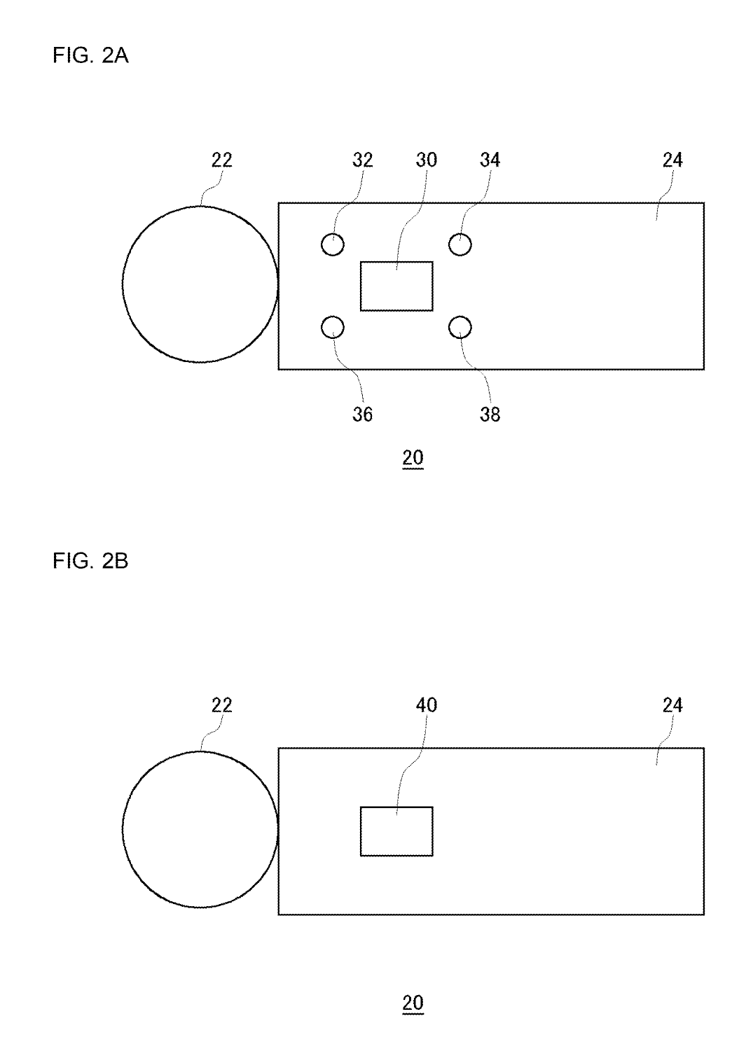

FIGS. 2A and 2B show the appearance of the input device 20. FIG. 2A shows the top surface of the input device 20, and FIG. 2B shows the bottom surface of the input device 20. The input device 20 comprises a light-emitting body 22 and a handle 24. The exterior of the light-emitting body 22 is formed of a light-transmitting resin into a spherical form. The light-emitting body 22 is provided with a light-emitting device such as a light-emitting diode or an electric bulb inside. When the light-emitting device inside emits light, the entirety of the exterior sphere is lighted. Control buttons 30, 32, 34, 36, and 38 are provided on the top surface of the handle 24, and a control button 40 is provided on the bottom surface. The user controls the control buttons 30, 32, 34, 36, and 38 with the thumb while holding the ends of the handle 24 with the user's hand. The control button 40 is controlled by the index finger. The control buttons 30, 32, 34, 36, and 38 are configured such that the buttons can be pressed. The user presses any of the buttons for use. The control button 40 may be used to enter an analog level.

The user plays the game viewing the game screen displayed on the display device 12. Because it is necessary to capture an image of the light-emitting body 22 while the game application is being run, the imaging device 14 is preferably oriented such that its imaging range faces the same direction in which the display device 12 faces. Typically, the user plays the game in front of the display device 12. Therefore, the imaging device 14 is arranged such that the direction of the light axis thereof is aligned with the frontward direction of the display device 12. More specifically, the imaging device 14 is preferably located to include in its imaging range those positions in the neighborhood of the display device 12 where the user can view the display screen of the display device 12. This allows the imaging device 14 to capture an image of the input device 12.

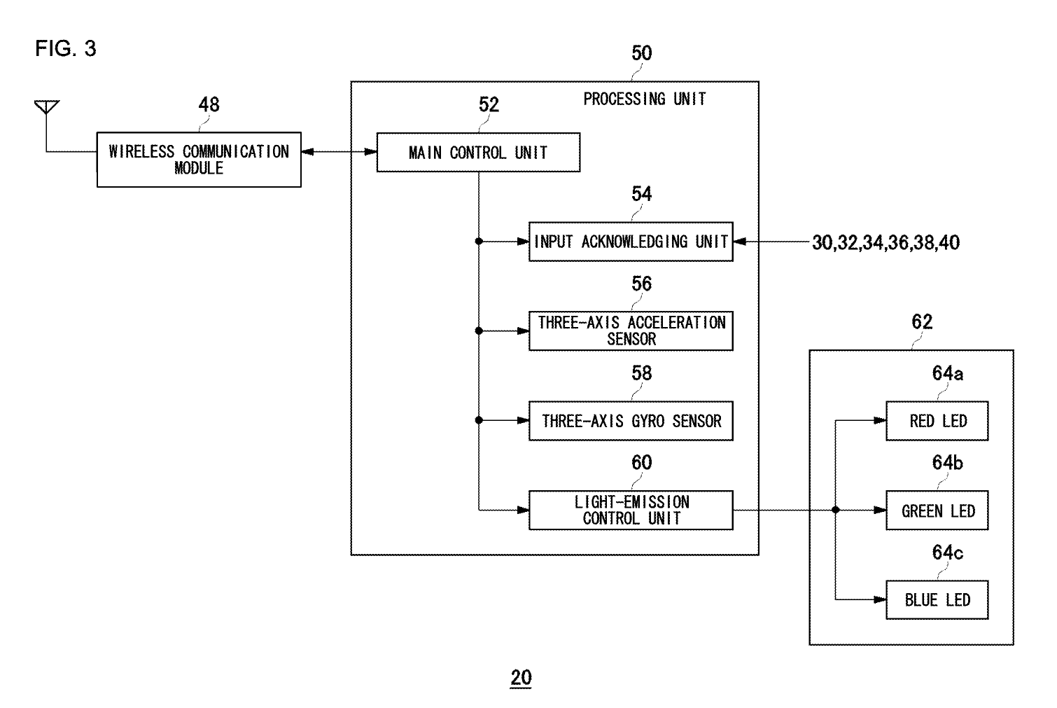

FIG. 3 shows the internal configuration of the input device 20. The input device 20 comprises a wireless communication module 48, a processing unit 50, a light-emitting unit 62, and the control buttons 30, 32, 34, 36, 38, and 40. The wireless communication module 48 has the function of transmitting and receiving data to and from the wireless communication module of the game device 10. The processing unit 50 performs required processes in the input device 20.

The processing unit 50 comprises a main control unit 52, an input acknowledging unit 54, a three-axis acceleration sensor 56, a three-axis gyro sensor 58, and a light-emission control unit 60. The main control unit 52 exchanges necessary data with the wireless communication module 48.

The input acknowledging unit 54 acknowledges input information from the control buttons 30, 32, 34, 36, 38, and 40 and sends the information to the main control unit 52. The three-axis acceleration sensor 56 detects acceleration components in three directions defined by X, Y, and Z axes. The three-axis gyro sensor 58 detects angular velocity on the XZ plane, ZY plane, and YZ plane. In this example, the width direction of the input device 20 is defined as the X-axis, the height direction as the Y-axis, and the longitudinal direction as the Z-axis. The three-axis acceleration sensor 56 and the three-axis gyro sensor 58 are provided in the handle 24 of the input device 20 and, more preferably, in the neighborhood of the center of the handle 24. Along with the input information from the control buttons, the wireless communication module 48 sends information on the value detected by the three-axis acceleration sensor 56 and information on the value detected by the three-axis gyro sensor 58 to the wireless communication module of the game device 10 at predetermined intervals. The interval of transmission is set to, for example, 11.25 milliseconds.

The light-emission control unit 60 controls light emission from the light-emitting unit 62. The light-emitting unit 62 comprises a red LED 64a, a green LED 64b, a blue LED 64c and is capable of emitting light of multiple colors. The light-emission control unit 60 adjusts light-emission from the red LED 64a, green LED 64b, blue LED 64c so as to cause the light-emitting unit 62 to emit light of a desired color.

In response to a command from the game device 10 to emit light, the wireless communication module 48 supplies the command to the main control unit 52, whereupon the main control unit 52 supplies the command to the light-emission control unit 60. The light-emission control unit 60 controls light-emission from the red LED 64a, green LED 64b, blue LED 64c so as to cause the light-emitting unit 62 to emit light of a color designated by the command. For example, the light-emission control unit 60 may control light emission from the LEDs using pulse width modulation (PWM) control.

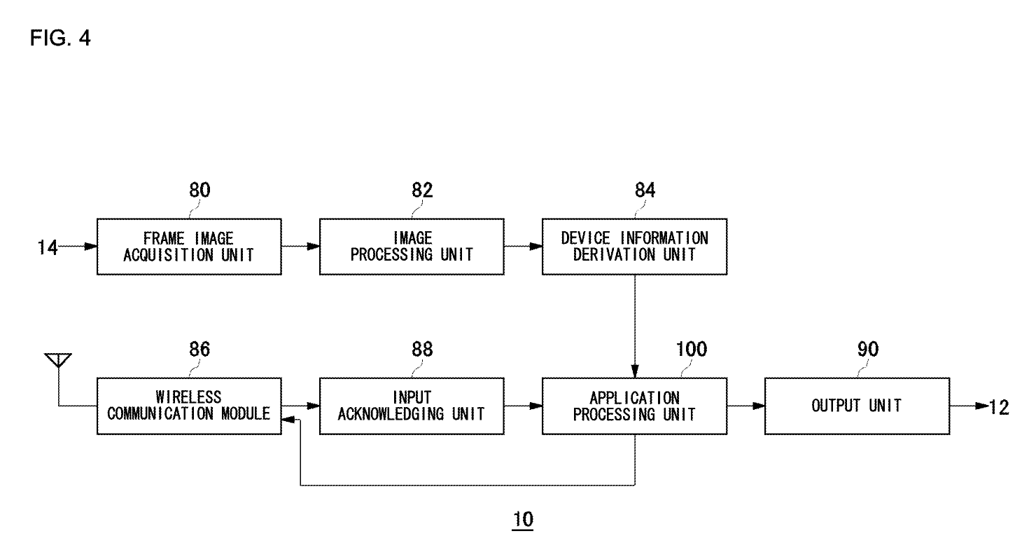

FIG. 4 shows the configuration of the game device 10. The game device 10 comprises a frame image acquisition unit 80, an image processing unit 82, a device information derivation unit 84, a wireless communication module 86, an input acknowledging unit 88, an output unit 90, and an application processing unit 100. The functions of the game device 10 are implemented by a CPU, a memory, and a program or the like loaded into the memory. FIG. 4 depicts functional blocks implemented by the cooperation of these elements. The program may be built into the game device 10 or supplied from an external source in the form of a recording medium. Therefore, it will be obvious to those skilled in the art that the functional blocks may be implemented in a variety of manners by hardware only, software only, or a combination of thereof. The game device 10 may comprise a plurality of CPUs as required by the hardware configuration.

The wireless communication module 86 establishes wireless communication with the wireless communication module 48. This allows the input device 20 to transmit information on the status of the control buttons, and information on values detected by the three-axis acceleration sensor 56 and the three-axis gyro sensor 58 to the game device 10 at predetermined intervals.

The wireless communication module 86 receives information on the status of the control buttons and information on values detected by the sensors, which are transmitted by the input device 20, and supplies the information to the input acknowledging unit 88. The input acknowledging unit 88 isolates the button status information from the sensor value information and delivers the information and the value to the application processing unit 100. The application processing unit 100 receives the button status information and the sensor value information as a command to control the game. The application processing unit 100 deals with the sensor value information as the orientation information of the input device 20.

The frame image acquisition unit 80 is configured as a USB interface and acquires frame images at a predetermined imaging speed (e.g., 30 frames/sec) from the imaging device 14. The image processing unit 82 extracts an image of the light-emitting body from the frame image. The image processing unit 82 identifies the position and size of the image of the light-emitting body in the frame image. By causing the light-emitting body 22 of the input device 20 to emit light in a color not likely to be used in the user's environment, the image processing unit 82 can extract the image of the light-emitting body with high precision. The image processing unit 82 may binarize the frame image data using predetermined threshold value and generate a binarized image. Binarization encodes pixel values of pixels having luminance higher than a predetermined threshold value into “1” and encodes pixel values of pixels having luminance equal to or lower than the predetermined threshold value into “0”. By lighting the light-emitting body 22 with luminance exceeding the threshold value, the image processing unit 82 can identify the position and size of the image of the light-emitting body from the binarized image. For example, the image processing unit 82 identifies the barycentric coordinates of the image of the light-emitting body in the frame image and identifies the radius of the image of the light-emitting body.

The device information derivation unit 84 derives the positional information of the input device 20 as viewed from the imaging device 14 by referring to the position and size of the image of the light-emitting body identified by the image processing unit 82. The device information derivation unit 84 derives the position coordinates in the camera coordinate system by referring to the barycentric coordinates of the image of the light-emitting body and derives the distance information indicating the distance from the imaging device 14 by referring to the radius of the of the image of the light-emitting body. The position coordinates and the distance information form the positional information of the input device 20. The device information derivation unit 84 derives the positional information of the input device 20 for each frame and delivers the information to the application processing unit 100. The application processing unit 100 deals with the positional information of the input device 20 as a command to control the game.

The application processing unit 100 uses the positional information, orientation information, and button status information of the input device 20 to advance the game, and generates an image signal indicating the result of processing the game application. The image signal is sent from the output unit 90 to the display device 12 and output as a displayed image.

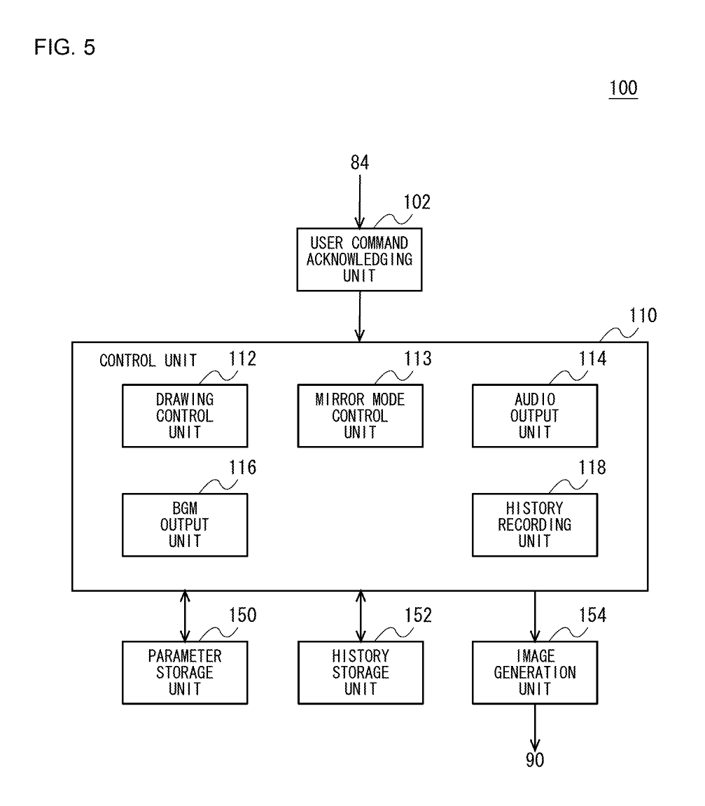

FIG. 5 shows the configuration of the application processing unit 100. The application processing unit 100 comprises a user command acknowledging unit 102, a control unit 110, a parameter storage unit 150, a history storage unit 152, and, and an image generation unit 154.

The user command acknowledging unit 102 acknowledges the positional information of the input device 20 from the device information derivation unit 84 and acknowledges the orientation information and the button state information of the input device 20 from the input acknowledging unit 88 as user commands. The control unit 110 runs the game program and advances the game in accordance with the user command acknowledged by the user command acknowledging unit 102. The parameter storage unit 150 stores parameters necessary for the progress of the game. The history storage unit 152 stores game history data. The image generation unit 154 superimpose a picture drawn by the control unit 110 on an image captured by the imaging device 14, and added various kinds of information to the image thus superimposed, whereby a display screen is generated.

The control unit 110 includes a drawing control unit 112, a mirror mode control unit 113, an audio output unit 114, a BGM output unit 116, and a history recording unit 118.

The drawing control unit 112 draws a picture based upon the positional information and the button state information of the input device 20. The drawing control unit 112 moves a pointer which indicates the position at which a picture can be drawn, according to changes in the position of the input device 20. The drawing control unit 112 may handle the image of the light-emitting body 22 of the input device 20 captured by the imaging device 14 as a pointer. Also, the drawing control unit 112 may display an image of a pen, a mouse pointer, or the like, as a pointer at a position of the light-emitting body 22. The drawing control unit 112 includes a one-frame image buffer, and is configured to draw a picture using a kind of pen that is currently selected, at a position on the screen according to the pointer position, in a color that is currently selected. For example, when a pen that is 4 dots in diameter is selected, the drawing control unit 112 draws a picture with a radius of 2 dots with the position of the input device 20 as the center, in a color that is currently selected. When the control button 36 of the input device 20 is pressed, the drawing control unit 112 presents a menu image which allows the player to select a color and a kind of pen, acknowledges the selection from the player, and stores the user's selection result in the parameter storage unit 150. The drawing control unit 112 may adjust the effects on the picture-drawing according to the distance between the input device 20 and the imaging device 14. For example, when the player draws a picture using a spray pen, the drawing control unit 112 may be configured such that, as the distance between the input device 20 and the imaging device 14 becomes greater, the picture width thus drawn becomes wider and diffuse, and such that, as the distance between the input device 20 and the imaging device 14 becomes smaller, the picture width thus drawn becomes narrower and concentrated.

The mirror mode control unit 113 controls a mirror mode in which, when the drawing control unit 112 controls the picture drawing operation of the input device 20, a screen is divided into multiple sub-screens, and a video image of the sub-screen that corresponds to the position at which the input device 20 is displayed, or otherwise a mirror image of this video image, is displayed on a different sub-screen. Detailed description will be made later regarding the operation of the mirror mode control unit 113.

The BGM output unit 116 outputs a background sound when the user plays the game. The BGM output unit 116 repeatedly outputs, as background music, a musical phrase of a predetermined length, e.g., a two-bar musical phrase.

The audio output unit 114 outputs a sound according to the position of the input device 20 or otherwise the position of the pointer when the picture is drawn, based upon the positional information and the button state information of the input device 20. When the picture is being drawn according to the pressing operation for the control button 40 of the input device 20, the audio output unit 114 outputs a sound with musical intervals, volume, and sound effects according to the position of the input device 20.

The audio output unit 114 includes a sound buffer which is capable of storing eight channels of musical phrases each having the same length as that of the unit of background sound to be output from the BGM output unit 116, e.g., the length of a two-bar musical phrase. The audio output unit 114 instructs the sound buffer to store, in units of two-bar musical phrases, a sound output according to the position of the input device 20. The audio output unit 114 superimposes the sound stored in the sound buffer on the background sound output from the BGM output unit 116, and outputs the resulting sound. Thus, eight channels of music played by the player are superimposed on the BGM, and the resulting musical sound is output.

The audio output unit 114 may adjust the musical intervals, sound length, sound effects, and so forth, before the sound output according to the position of the input device 20 is stored in the sound buffer. In a case in which the timing at which the control button 40 of the input device 20 is pressed does not match the onset of the beat, the audio output unit 114 may store the sound such that its timing matches the onset of the beat. For example, in a case in which the musical sound is configured in four-four time, the audio output unit 114 may perform timing adjustment such that the timing at which the sound output is started matches the onset of a one-eighth beat which is obtained by dividing a single-bar musical phrase into eight equal parts. When the timing at which the control button 40 is pressed does not match the onset of the beat, the audio output unit 114 may adjust the timing such that the timing at which the control button 40 is pressed matches the onset of the next or otherwise immediately previous beat. Also, when the timing at which the control button 40 is pressed occurs before a halfway point between beats, the audio output unit 114 may adjust the timing such that the timing at which the control button 40 is pressed matches the onset of the immediately previous beat. Conversely, when the timing at which the control button 40 is pressed occurs after a halfway point between beats, the audio output unit 114 may adjust the timing such that the timing at which the control button 40 is pressed matches the onset of the next beat. The audio output unit 114 may adjust the sound such that it has a sound length that is an integer multiple of the unit of music length.

The audio output unit 114 switches the sound type of the sound to be output every time the player draws a picture line. The audio output unit 114 holds the order of the sound types. When the player releases the control button 40, the audio output unit 114 switches the sound type to the next sound type according to the sound type order. Also, the audio output unit 114 may switch the sound type for every predetermined length that is the same as the length of a unit of background sound output from the BGM output unit 116, e.g., for every two-bar musical phrase. Also, the audio output unit 114 may hold a sound palette such that the respective sound types are associated with the respective kinds of pens to be selected by the player. When the player changes the kind of pen, the audio output unit 114 may switch the current sound type to the sound type associated with the kind of pen.

Also, the audio output unit 114 may adjust the musical intervals, volume, and sound effects of the sound to be output, according to the speed at which the input device 20 is moved. For example, the audio output unit 114 may raise the volume according to an increase in the speed at which the input device 20 is moved. Also, the audio output unit 114 may adjust the musical intervals, volume, and sound effects of the sound to be output, according to the distance between the input device 20 and the imaging device 14. For example, the audio output unit 114 may increase the echo effect to be applied to the sound, according to an increase in the distance between the input device 20 and the imaging device 14.

The history recording unit 118 instructs the history holding unit 152 to store the image captured by the imaging device 14, the picture drawn by the player, and the sound output when the user draws the picture. The history recording unit 118 may store such information items as a single information set in the form of moving image data. Also, the history recording unit 118 stores the image data, the picture data, and the sound data, as separate data items. The picture data may be configured as image data for each frame. Also, the picture data may be configured as the positional information and the button state information of the input device 20 stored in a time series manner. Also, the history recording unit 118 may instruct the history storage unit 152 to store the image and sound only when the player presses the control button 40 of the input device 20 so as to draw a picture. That is to say, the storage of the image may be suspended when the player is not drawing a picture. For example, when the player changes the kind of pen or the color via the menu screen, the history storage may be suspended. The history data stored in the history storage unit 152 may be configured as public data accessible by other players via a server or the like. Such an arrangement allows the player not only to exhibit a picture itself drawn by the player, but also to exhibit, as a form of performance, the entire process of the player drawing a picture together with the musical sound played via the input device 20.

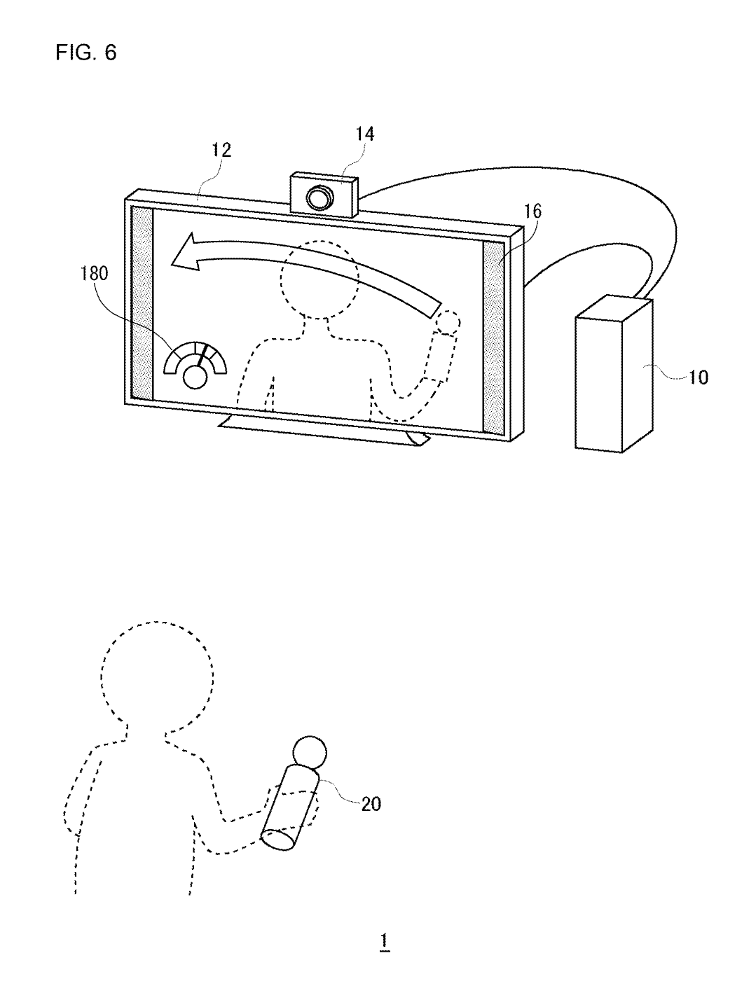

FIG. 6 shows the player drawing a picture using the game device according to the embodiment. The image generation unit 154 instructs the display device 12 to display an image captured by the imaging device 14. Furthermore, the display device 12 displays the image of the player holding the input device 20. Furthermore, a speaker 16 outputs background music output from the BGM output unit 116. The display device 12 displays an indicator 180 which changes its indication according to the rhythm of the background music. Here, when the player moves the input device 20 while pressing the control button 40 of the input device 20, the drawing control unit 112 draws a picture by following the track of movement of the input device 20 moved by the player.

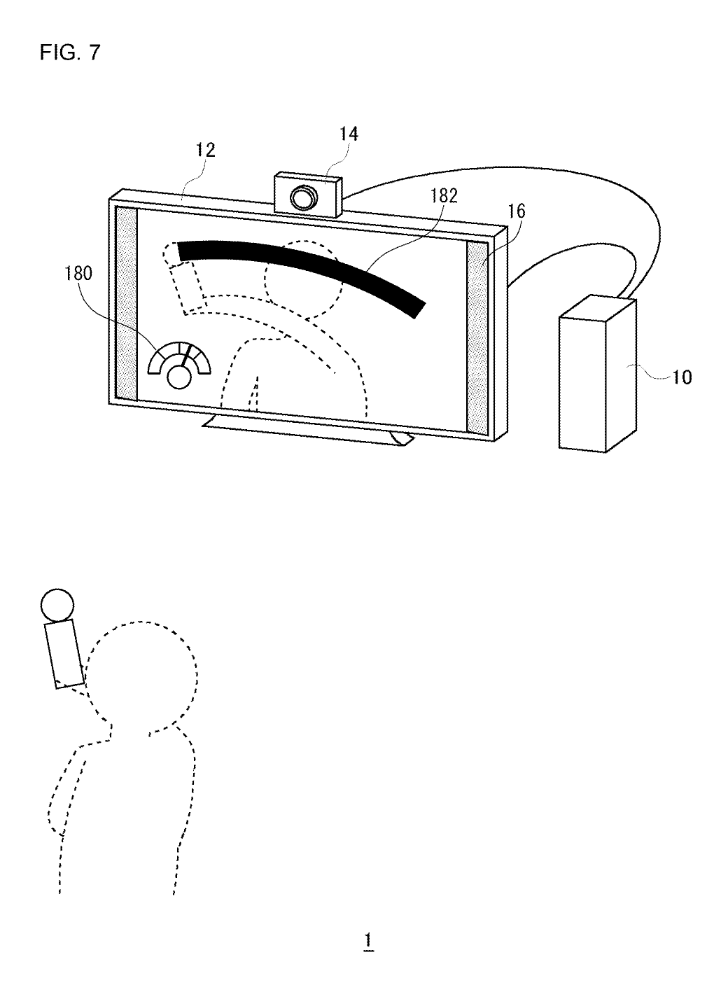

FIG. 7 shows the player drawing a picture using the game device according to the embodiment. The image generation unit 154 instructs the display device 12 to display an image obtained by superimposing a picture 182 drawn by the drawing control unit 112 on an image captured by the imaging device 14. In this stage, the audio output unit 114 acquires the positional information with respect to the input device 20, and outputs sound according to the position of the input device 20 when the control button 40 of the input device 20 is being pressed and a picture is being drawn.

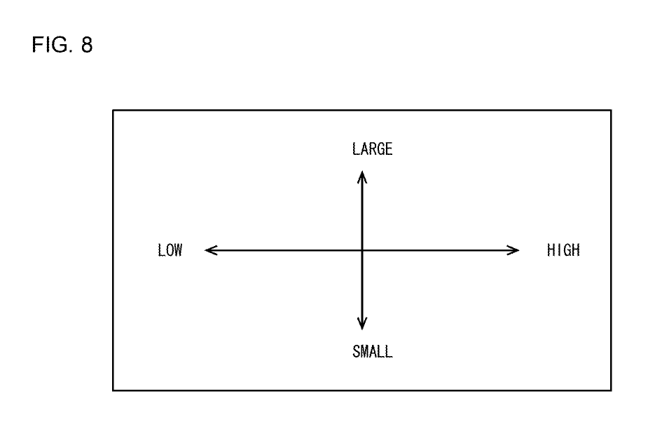

FIG. 8 shows the properties of a sound which is output from the audio output unit according to the position of the input device. In an example shown in FIG. 8, the tone of the sound is changed according to the position of the input device 20 along the horizontal direction. Specifically, as the input device 20 is moved rightward, the tone becomes higher, and as the input device 20 is moved leftward, the tone becomes lower. Furthermore, as the input device 20 is moved upward, the volume of the sound becomes larger, and as the input device is moved downward, the volume of the sound becomes smaller. Thus, as shown in FIG. 6 and FIG. 7, when a line is drawn from the right to the left, the audio output unit 114 outputs a sound with a tone that gradually becomes lower from a high tone that corresponds to the drawing start position.

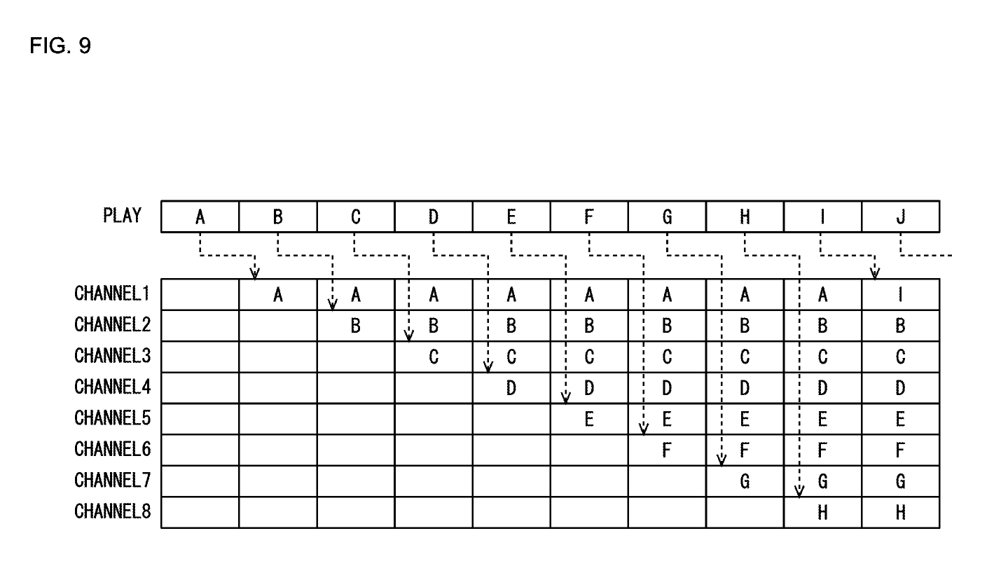

FIG. 9 shows an example of the sound output from the audio output unit. The audio output unit 114 instructs the sound buffer to store, in units of predetermined lengths, the music played by the player by operating the input device 20. Immediately after the player starts to draw a picture, the audio output unit 114 outputs the background music and a phrase A played by the player. As the next phrase, a phrase obtained by superimposing a phrase B played in the current stage on the phrase A which was played in the previous stage and is stored in the channel 1 is output. As the subsequent phrase, a phrase obtained by superimposing a phrase C played in the current stage on the phrase A stored in the channel 1 and the phrase B stored in the channel 2 is output. As described above, such an arrangement outputs a musical phrase obtained by superimposing a maximum of eight channels of musical phrases. After the eight channels of the sound buffer are all used for the musical phrase storage, the musical phrase played in the next stage is stored by overwriting the channel storing the musical phrase played in the earliest stage.

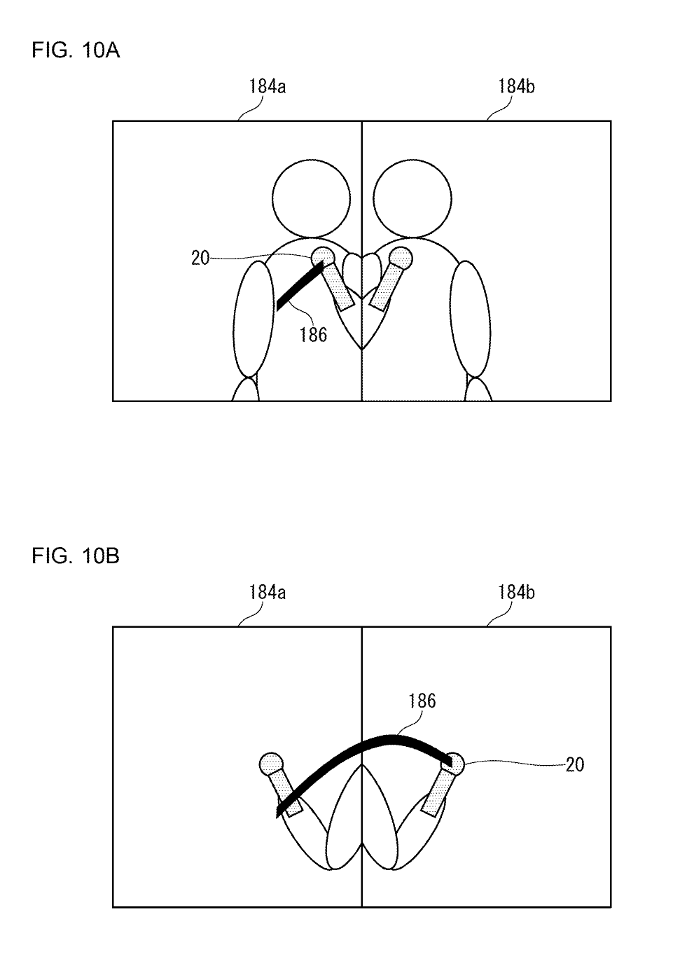

FIGS. 10A and 10B are diagrams for describing the operation of the mirror mode control unit. When the drawing control unit 112 controls the picture drawing operation of the input device 20, the mirror mode control unit 113 divides a screen into multiple sub-screens, and the video image displayed on the sub-screen on which the input device 20 is displayed, or otherwise the mirror image thereof, is displayed on a different sub-screen. FIGS. 10A and 10B each show an example in which a screen is divided into two sub-screens, i.e., a left screen 184a and a right screen 184b. In FIG. 10A, the light-emitting body 22 of the input device 20 is displayed on the left screen 184a. Thus, the mirror mode control unit 113 displays, on the right screen 184b, the mirror image of the video image displayed on the left screen 184a. In FIG. 10B, the position of the light-emitting body 22 of the input device 20 has changed to the right screen 184b. Thus, the mirror mode control unit 113 displays, on the left screen 184a, the mirror image of the video image displayed on the right screen 184b. The drawing control unit 112 draws a picture 186 by following the track of the light-emitting body 22 of the input device 20 in the same way as in the ordinary mode as described above. This provides video effects on the screen on which the player draws a picture, which provides improved entertainment.

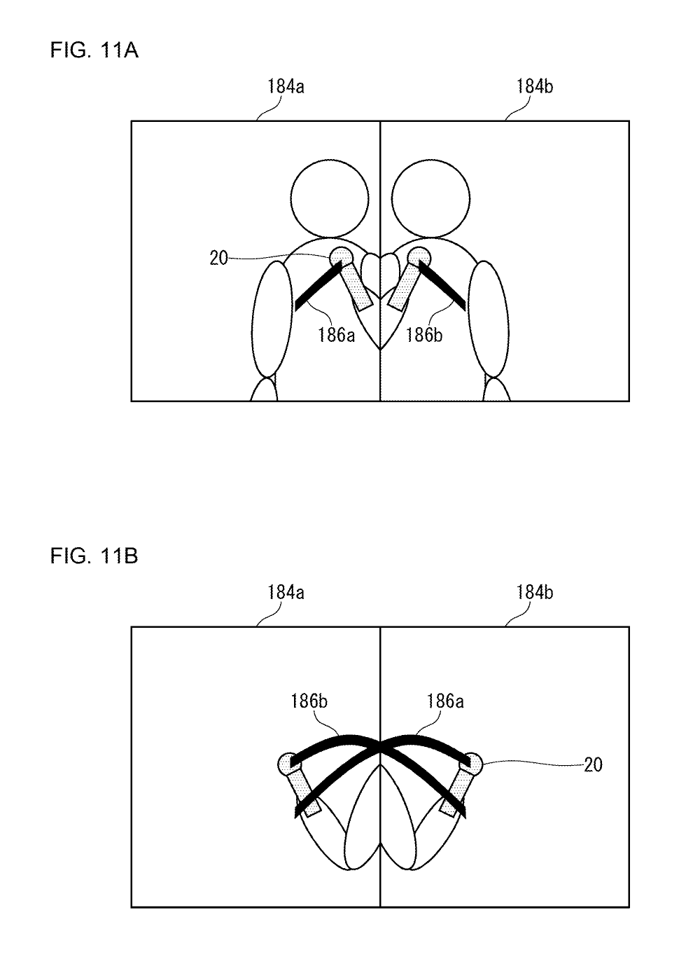

FIGS. 11A and 11B are diagrams each showing the operation of the mirror mode control unit 113. Such an arrangement shown in FIGS. 11A and 11B allows the user not only to display a mirror image of a video image acquired by the imaging device 14, but also to display, as a picture, a mirror image 186b of a track 186a of the light-emitting body 22 of the input device 20. Thus, such an arrangement provides a function of allowing the user to easily draw a picture which is line-symmetric with respect to the boundary between the left screen 184a and the right screen 184b.

When the user is drawing a picture in the mirror mode, the mirror mode control unit 113 may instruct the audio output unit 114 to output a sound obtained by superimposing the same number of sounds as there are sub-screens. In this stage, in addition to a sound to be output in the ordinary mode, the mirror mode control unit 113 may instruct the audio output unit 114 to output a sound that is transformed according to a predetermined rule, e.g., a sound that is one octave higher or lower. Also, in FIGS. 11A and 11B, in addition to a sound to be output when the picture 186a is drawn, the mirror mode control unit 113 may instruct the audio output unit 114 to output a sound which is to be output when the picture 186b is to be drawn.

### Second Embodiment

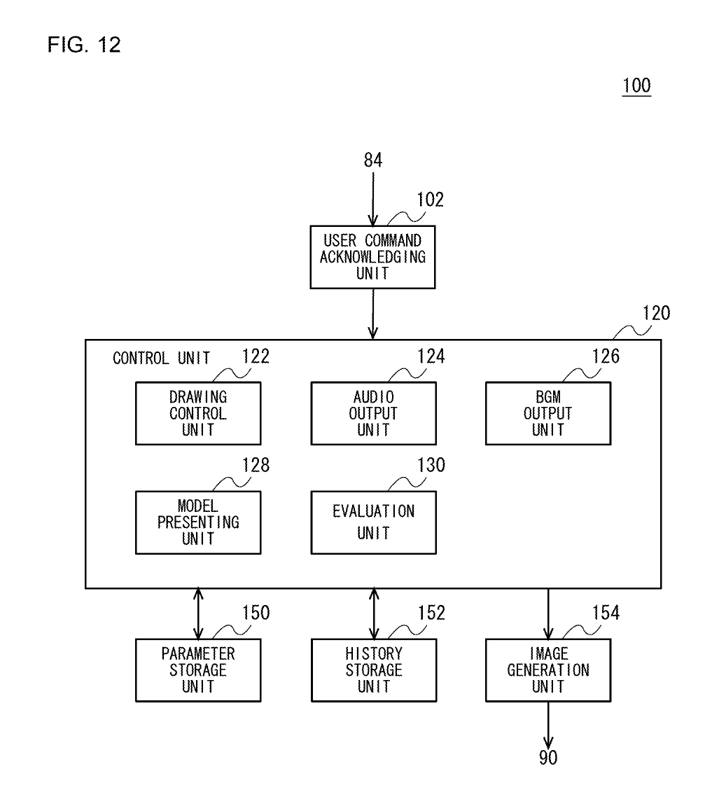

Description will be made in the second embodiment regarding a game in which a model picture which the player is to draw is presented to the player, and the player competes on the basis of the accuracy of the picture the player draws. FIG. 12 shows a configuration of an application processing unit 100 according to the second embodiment. The application processing unit 100 according to the present embodiment includes a control unit 120, instead of the control unit 110 included in the application processing unit 100 according to the first embodiment. The other components and operations are the same as those of the first embodiment.

The control unit 120 includes a drawing control unit 122, an audio output unit 124, a BGM output unit 126, a model presenting unit 128, and an evaluation unit 130.

The model presenting unit 128 reads out, from an unshown game data storage unit, model data of a picture which the player is to draw, and presents the model data to the player. The model presenting unit 128 may present, as a model, the entire picture which the player is to draw, before it acknowledges the player's drawing. Also, the model picture may be divided into multiple lines. Such an arrangement may be configured to repeatedly perform a procedure comprising a step in which the model presenting unit 128 presents the next line of the model which the player is to draw, and a step in which this line is drawn by the player. The model presenting unit 128 presents a process for drawing a model which the player is to draw, in time to the background sound output from the BGM output unit 126. Thus, such an arrangement allows the player to understand the timing at which the player is to start to draw the picture, the speed at which the player is to draw the picture, and the timing at which the player is to finish drawing the picture, and to draw the picture at the same timing as that of the model. As another example, the model presenting unit 128 may present only a complete form of the model picture which the player is to draw.

The drawing control unit 122 controls the picture drawing operation based on a control command by the player via the input device 20. The drawing control unit 122 draws a picture by following the track of movement of the input device 20 moved by the player, in the same way as in the first embodiment. The drawing control unit 122 automatically selects a pen type and color suitable for the picture presented by the model presenting unit 128. The drawing control unit 122 may be configured to allow the player to select a pen type and color suitable for the model.

The evaluation unit 130 compares the model with the shape and the drawing timing of the picture drawn by the drawing control unit 122 according to an instruction from the player, and evaluates the accuracy of the picture drawn by the player. The evaluation unit 130 judges: line bonus points to be awarded to the player when the difference in the position between the model line which the player is to draw and the line actually drawn by the player is within a predetermined range at the start point, the end point, and intermediate points; and rhythm bonus points to be awarded to the player when the difference between the model timing and the actual timing at which the player drew the track is within a predetermined range at the aforementioned points. The evaluation unit 130 awards points to the player calculated based upon the line bonus points and the rhythm bonus points.

The evaluation unit 130 manages a life gauge which indicates points necessary for the player to continue the game. When the evaluation unit 130 judges that there is a great difference in the shape or otherwise the drawing timing between the model picture and the picture drawn by the player, the evaluation unit 130 reduces the life gauge according to the scale of the difference. When the life gauge becomes lower than a predetermined value, the evaluation unit 130 judges that the game is over.

When the model presenting unit 128 presents the model picture, or when the drawing control unit 122 acknowledges a drawing instruction from the player, the BGM output unit 126 outputs a background sound which functions as an indication of the drawing timing for the player. The BGM output unit 126 may repeatedly output, as background music, a musical phrase having a predetermined length, e.g., a two-bar musical phrase, in the same way as in the first embodiment.

When the model presenting unit 128 presents the model picture, or when the player draws a picture, the audio output unit 124 outputs sound. Basically, when the player draws a picture, the audio output unit 124 outputs a sound that was output in the immediately previous stage in which the model presenting unit 128 presents a model picture. In addition, the audio output unit 124 is configured to adjust the sound to be output, based upon the evaluation result obtained by the evaluation unit 130. For example, when the evaluation result obtained by the evaluation unit 130 is lower than a predetermined value, the audio output unit 124 switches the sound to a gloomy and sad tone. Also, the audio output unit 124 may be configured to store such a sound to be output when the evaluation result is low, and to switch the sound to such a sound thus stored. Also, the audio output unit 124 may be configured to switch the sound by changing the musical intervals, volume, sound effects, and so forth. When the evaluation result obtained by the evaluation unit 130 is higher than a predetermined value, the audio output unit 124 may be configured to switch the sound to a bright and enjoyable tone.

The audio output unit 124 may output a sound according to the position of the input device 20, in the same way as with the first embodiment. With such an embodiment, when the evaluation result obtained by the evaluation unit 130 is lower than a predetermined value when the player is drawing a picture, the audio output unit 124 is configured to switch the sound to a gloomy and sad tone by changing the musical intervals, volume, sound effects, and so forth.

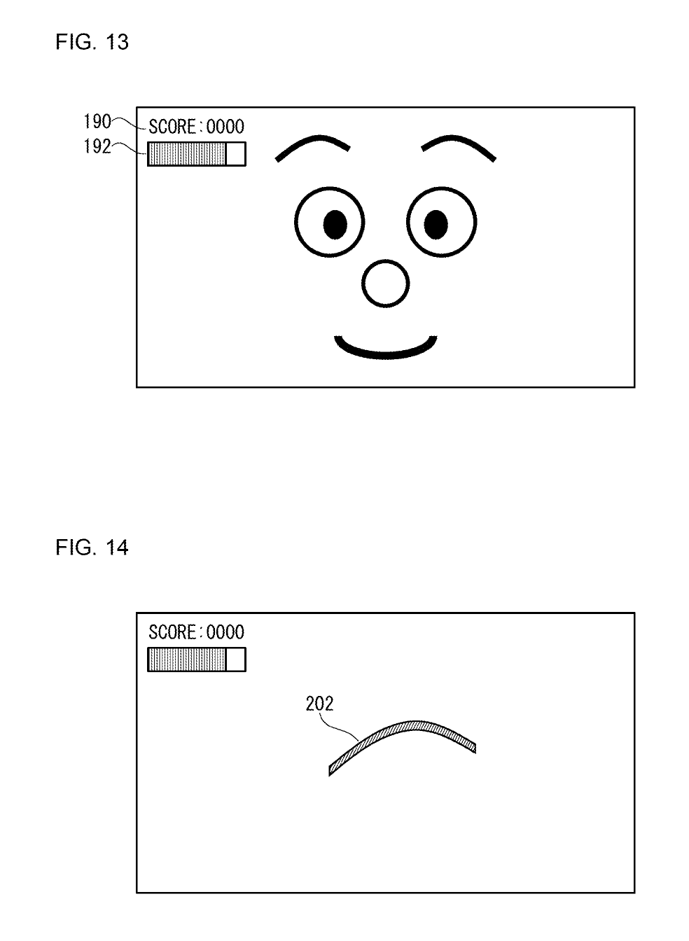

FIG. 13 shows a model picture which the player is to draw. The model presenting unit 128 may present the entire model picture in a complete form when the game is started. Also, the model presenting unit 128 may present only a single line before every step in which the player is to draw such a single line, which allows the player to understand the complete form of the picture after the player finishes all the drawing steps. On the display screen, a score field 190 which displays the total points awarded to the player, and a life gauge field 192 which indicates the current life gauge, are displayed.

FIG. 14 shows a screen which presents a model line which the player is to draw in the next stage. The model presenting unit 128 presents, in an enlarged manner, a line 202 which is the portion of the picture which the player is to draw in the next stage. This allows the player to easily draw a picture accurately. Furthermore, such an arrangement prompts the player to make a large gesture, thereby providing a game with higher entertainment value. The model presenting unit 128 is configured to draw a model picture at a timing and a speed at which the player is to draw, in time to the background music output from the BGM output unit 126 and the music output from the audio output unit 124. Thus, such an arrangement presents to the player a drawing process that indicates at what timing the player is to start to draw a line, with what speed the player is to draw a picture, and at what timing the player is to finish drawing a picture.

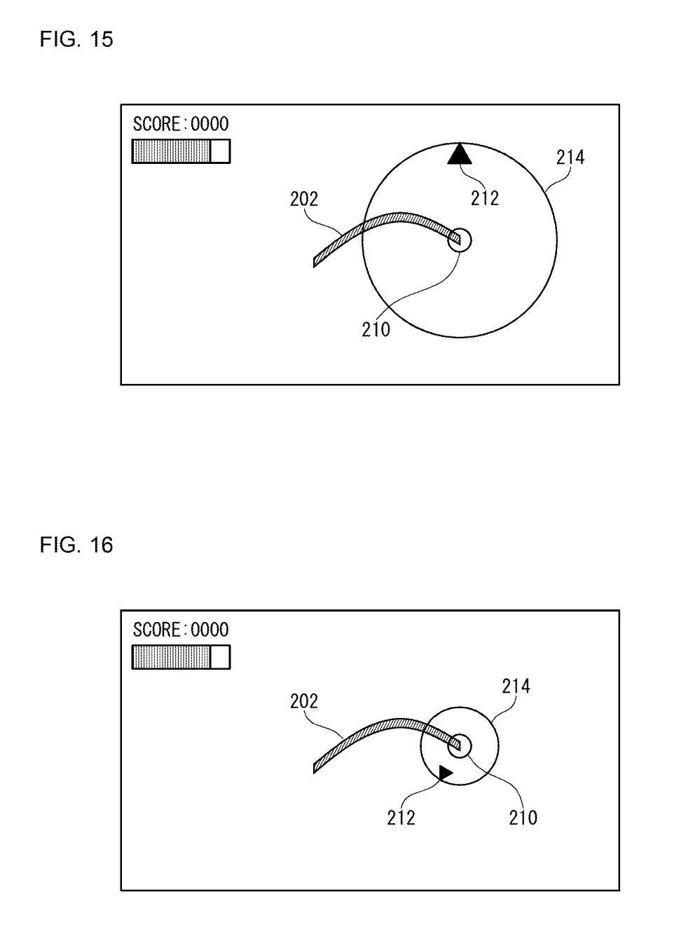

FIG. 15 shows an example of a screen configured to present a timing at which the player is to draw a line in the next stage. After the model presenting unit 128 presents a model picture, or otherwise when the model presenting unit 128 presents a model picture, the model presenting unit 128 presents a circle 214 and a clock hand 212 each configured as an indictor of a timing at which the player is to start to draw a line, and a circle 210 configured as an indicator of the position at which the player is to start to draw a line. The model presenting unit 128 is configured to gradually reduce the size of the circle 214 with the position at which the player is to start to draw a line as the center, and to rotate the clock hand 212 in the clockwise direction. Such an operation is performed such that, at a timing at which the player is to start to draw a line, the size of the circle 214 becomes the same as that of the circle 210, and the clock hand 212 is positioned at the 0 o'clock position after it has made one rotation. Thus, such an arrangement presents a timing and a position at which the player is to start to draw a line.

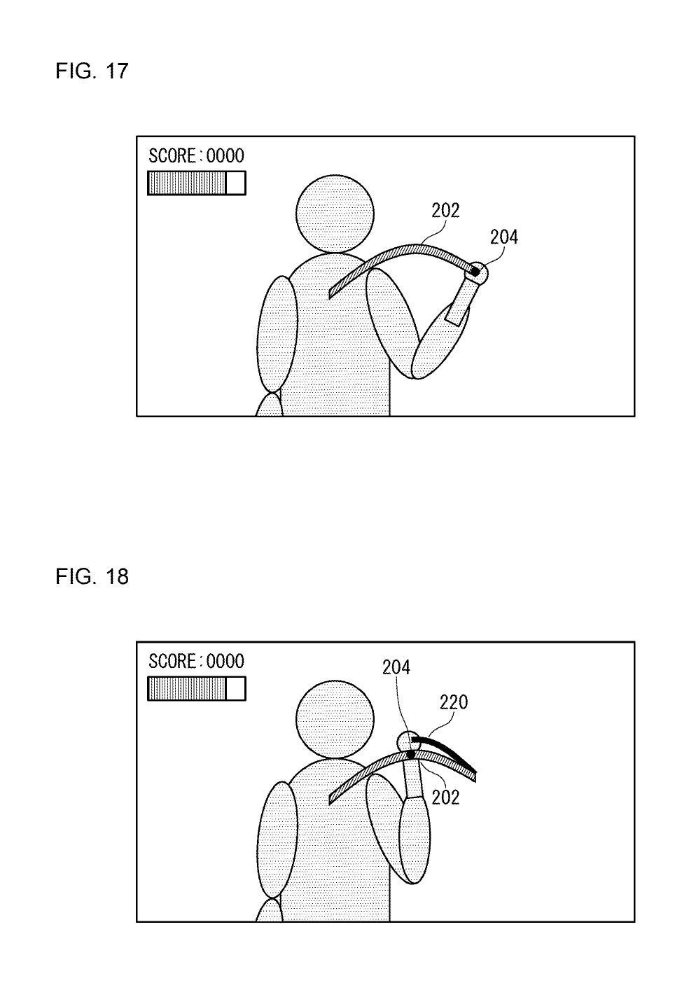

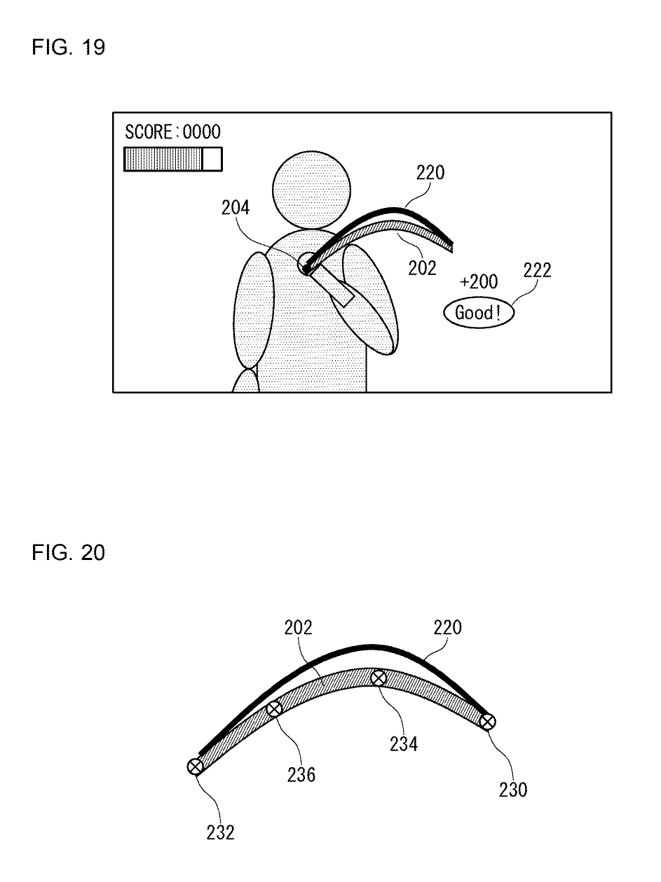

FIGS. 17, 18, and 19, each show the player drawing a line imitating the model picture. As with the first embodiment, by moving the input device 20 along the line 202 which is presented as a model picture, such an arrangement allows the player to draw the line 220 as shown in FIG. 19. Such an arrangement allows the player not only to accurately trace the line 202 presented as a model picture, but also to draw such a picture at a timing and a speed presented by the model presenting unit 128. In this stage, the evaluation unit 130 makes a comparison with respect to the shape and the drawing timing between the line 220 and the model line 202, evaluates how accurately the player drew this line, and displays the evaluation result 222 on the screen.

Before the player draws a line imitating a model picture, in order to present to the player the position and the timing at which the player is to draw this line, the model presenting unit 128 displays a marker 204 which is moved along the line 202 presented as a model picture 202 such that it is located at a position where the player is to draw the line and at a timing at which the player is to draw the line. The player moves the input device 20 such that the marker 204 which moves along the line 202 matches the light-emitting body 22 of the input device 20, thereby allowing the player to draw a picture accurately according the model picture.

FIG. 20 is a diagram for describing a method employed by the evaluation unit for evaluating how accurately the player has drawn a picture. The evaluation unit 130 performs evaluation based upon the difference in the position and the timing with respect to multiple respective points included in the model picture 202. In the example shown in FIG. 20, evaluation is performed based upon the difference in the position and the timing with respect to a start point 230, an end point 232, and intermediate points 234 and 236 between the start point 230 and the end point 232.

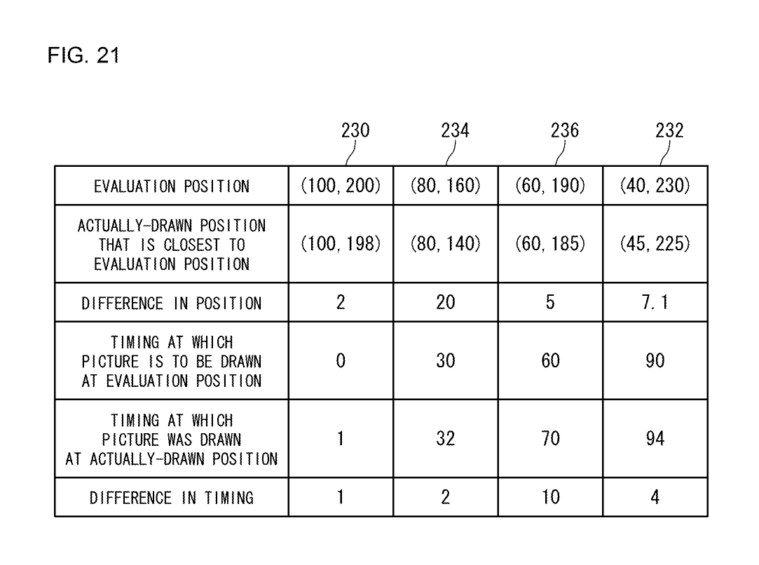

FIG. 21 shows an example of the evaluation result obtained by the evaluation unit. For the multiple evaluation points shown in FIG. 20, such an arrangement calculates the actually-drawn position that is closest to each evaluation position, the difference in position between the evaluation point and the actually-drawn position, the timing at which the player drew the actually-drawn position, and the difference in timing between the model timing at which the player was to draw the evaluation point and the actual timing at which the player drew the actually-drawn point. When the difference in position is smaller than a predetermined value for each evaluation point, the evaluation unit 130 awards a predetermined “line bonus” to the player. Moreover, when the difference in timing is smaller than a predetermined value, the evaluation unit 130 awards a predetermined “rhythm bonus” to the player. The evaluation unit 130 calculates the sum total of the line bonuses and the rhythm bonuses for the respective evaluation points, thereby calculating the evaluation result which indicates how accurately the player drew the line 220.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

What is claimed is:

1. A game control program embedded in a non-transitory computer readable recording medium, comprising:
a movement control module configured to move a pointer that indicates a drawing position based on a control command of a player;
a module configured to draw a picture at a position of the pointer based on a control command of the player; and
a module configured to output sound as determined by the position of the pointer when the picture is drawn.

2. A game control program according to claim 1, further comprising a module configured to capture an image of the player holding an input device that allows the player to input an instruction,
wherein the movement control module moves the pointer so as to follow a track of movement of the input device that is moved by the player.

3. A game control program according to claim 2, further comprising a module configured to display, on a display device, the image thus captured and the picture thus drawn in a superimposed manner.

4. A game control program according to claim 1, further comprising a module configured to repeatedly output a background sound having a predetermined length, during a period of time in which the player is drawing the picture.

5. A game control program according to claim 4, further comprising:
a recording module configured to record the sound that has been output based on the position of the pointer; and
an outputting module configured to output the sound thus stored and the background sound in a superimposed manner.

6. A game control program according to claim 5,
wherein the recording module records the sound in a plurality of channels each having a predetermined length respectively, and
wherein the outputting module outputs the sounds each stored in the plurality of channels together with the background sound in a superimposed manner.

7. A game control program according to claim 2, further comprising a module configured to record the image thus captured, the picture thus drawn, and the sound thus output, as history data.

8. A game control program according to claim 3, further comprising:
a module configured to divide a screen of the display device into multiple sub-screens; and
a module configured to display an image displayed on a sub-screen that corresponds to a position at which the input device is to be displayed, or a mirror image thereof, on a different sub-screen thus divided.

9. A game device comprising:
a drawing control unit configured to move a pointer which indicates a drawing position based on a control command of a player, and to draw a picture at a position of the pointer based on a control command of the player; and
a sound output unit configured to output sound as determined by the position of the pointer when the picture is drawn.

10. A game control method comprising:
moving a pointer that indicates a drawing position based on a control command of a player;
drawing a picture at a position of the pointer based on a control command of the player; and
outputting sound as determined by the position of the pointer when the picture is drawn.

11. A game control program embedded in a non-transitory computer readable recording medium, comprising:
a module configured to output background sound;
a module configured to display a process for drawing a first picture that a player is to draw, concurrently with the background sound;
a drawing module configured to draw a second picture based on an operating input of the player;
an evaluating module configured to evaluate the accuracy of a timing at which the player has drawn the second picture by making a comparison between a process in which the second picture was drawn and the process in which the first picture was drawn; and
an outputting module configured to output a sound based on the accuracy of the timing at which the player has drawn the second picture when the second picture is drawn.

12. A game control program according to claim 11, wherein the evaluating module evaluates the accuracy of the timing at which the player has drawn the second picture by calculating a difference between a timing at which a given point is to be drawn and a timing at which the player has drawn this point, with respect to a plurality of points included in the first picture.

13. A game control program according to claim 11, wherein the evaluating module further evaluates the accuracy of the player's drawing by making comparison between the shape of the second picture and the shape of the first picture,
and wherein the sound is further adjusted with reference to the accuracy of the player's drawing by the outputting module.

14. A game control program according to claim 13, wherein the evaluating module evaluates the accuracy of the player's drawing by calculating the difference in the position between the first picture and the second picture with respect to a plurality of points included in the first picture.

15. A game control program according to claim 11, further comprising a module configured to capture an image of the player holding an input device which allows the player to input the operating input,
wherein the drawing module draws the picture according to a track of movement of the input device that is moved by the player.

16. A game control program according to claim 15, further comprising a module configured to display, on a display device, the image thus captured and the second picture thus drawn in a superimposed manner.

17. A game control program according to claim 11, further comprising a module configured to output a background sound that functions as an indicator to indicate the timing at which the second picture is to be drawn, when the player is drawing the second picture.

18. A game control program according to claim 11, further comprising a module configured to display a marker that is moved along the first picture such that the marker is located at a position at which the player is to draw the second picture, at a particular time at which the player is to draw the second picture, in order to indicate to the player the position and the timing at which the player is to draw the second picture.

19. A game device comprising:
a background sound output unit configured to output background sound;
a model picture presenting unit configured to display a process for drawing a first picture that the player is to draw, concurrently with the background sound;
a drawing control unit configured to draw a second picture based on an operating input of the player;
an evaluation unit configured to evaluate the accuracy of the timing at which the player has drawn the second picture by making a comparison between a process in which the second picture was drawn and the process in which the first picture was drawn; and
a sound output unit configured to output a sound based on the accuracy of the timing at which the player has drawn the second picture when the second picture is drawn.

20. A game control method comprising:
outputting background sound;
displaying a process for drawing a first picture that the player is to draw, concurrently with the background sound;
drawing a second picture based on an operating input of the player;
evaluating the accuracy of the timing at which the player has drawn the second picture by making a comparison between a process in which the second picture was drawn and the process in which the first picture was drawn; and
outputting a sound based on the accuracy of the timing at which the player has drawn the second picture when the second picture is drawn.
